(19) United States
(12) Patent Application Publication
(10) Pub. No.: US 2004/0256061 A1
(43) Pub. Date: Dec. 23, 2004

(54) Double curtain with variable transparency

(76) Inventors: Gerhard Albert Krosenbrink, Winterswijk (NL); Remco Herman Joseph Roelofs, Almelo (NL)

Correspondence Address: YOUNG & THOMPSON, 745 SOUTH 23RD STREET, 2ND FLOOR, ARLINGTON, VA, 22202, US

(21) Appl. No.: 10/887,093

(22) Filed: Jul. 9, 2004

Related U.S. Application Data
(63) Continuation of application No. PCT/NL03/00005, filed on Jan. 7, 2003.

(30) Foreign Application Priority Data
Jan. 9, 2002 (NL) 1019714

(51) Int. Cl. E06B 3/48

(52) U.S. Cl. 160/84.03

(57) ABSTRACT

The invention relates to a window decoration (1) for partially or wholly covering a window (3) as desired, which window decoration (1) comprises: a first displaceable window covering element (4); and a second displaceable window covering (6) element arranged parallel to the first window covering element (4); wherein both window covering elements are transparent. Section of differing elements are transparent. Sections of differing transparency can thus be created with the window decoration (1) according to the invention.

The invention relates to a window decoration for partially or wholly covering a window as desired, which window decoration comprises:

a first displaceable window covering element; and

a second displaceable window covering element arranged parallel to the first window covering element.

Known for instance from U.S. Pat. No. 2,142,822 is a window decoration wherein two roller blinds are placed one behind the other. Each roller blind comprises horizontal strips with a better transparency compared to the other part of the blind. When the strips of both blinds run mutually parallel, a large amount of light is allowed through and when the roller blinds are displaced vertically over a small distance the whole window surface is darkened.

In an environment where VDU-work is carried out, it is necessary for the amount of light incident from outside to be reduced considerably so as to thus reduce or even prevent reflections in the screen.

The drawback of the above stated window decoration, or for instance a curtain or horizontal blind, is that the whole window surface is darkened and no light at all thus enters the room.

For a better working climate it is important that the window surface can be adequately darkened on the one hand and a sufficient view to the outside remains on the other.

It is an object of the invention to provide a window decoration which meets the above stated requirements.

This object is achieved with a window decoration according to the preamble which is characterized in that both window covering elements are transparent.

Transparent is understood to mean both transparent and translucent. The light incidence is decreased by lowering the first covering element. This decrease can be such that something on the other side of the window decoration can still be perceived. By lowering the second window covering element the light incidence is reduced further. By not lowering the second window covering element completely, the other side can still be perceived through the lower part of the window, while on the upper side the light incidence is reduced such that for instance no reflection occurs in screens.

In a preferred embodiment of a window decoration according to the invention, the first window covering element has a transparency differing from that of the second window covering element. Three different transparencies can thus be obtained using the window decoration according to the invention. The transparency of the first window covering element, the transparency of the second window covering element and the combined transparency of both window covering elements.

In a preferred embodiment of a window decoration according to the invention, the first window covering element has a transparency in the range of 2%-50% and the second window covering element a transparency in the range of 1%-10%.

It is much preferred that the first window covering element has a transparency of 20% and the second window covering element has a transparency of 5%. Three different transparencies can thus be created of 20%, 5% and 1%. The transparency of 20% ensures a view to the outside which is still good, while the intensity of the light, particularly on summer days, is reduced such that it is no longer inconvenient. A transparency of 1% results in the upper part of the window decoration by lowering the window covering element having a transparency of 5%. This has been found to be highly desirable for the purpose of reducing reflections in screens.

In yet another embodiment of the window decoration according to the invention, the first and second window covering elements each comprise one of a roller blind or a pleated blind.

These and other features of the invention are further elucidated with reference to the annexed figures.

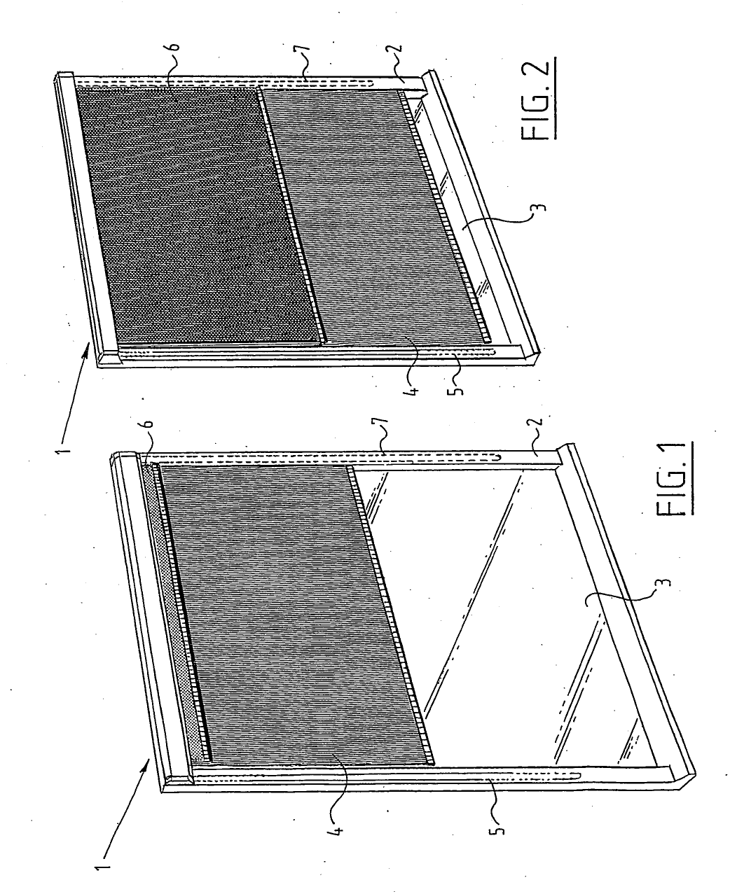

FIGS. 1 and 2 show a first embodiment of a window decoration according to the invention in two 20′ different positions.

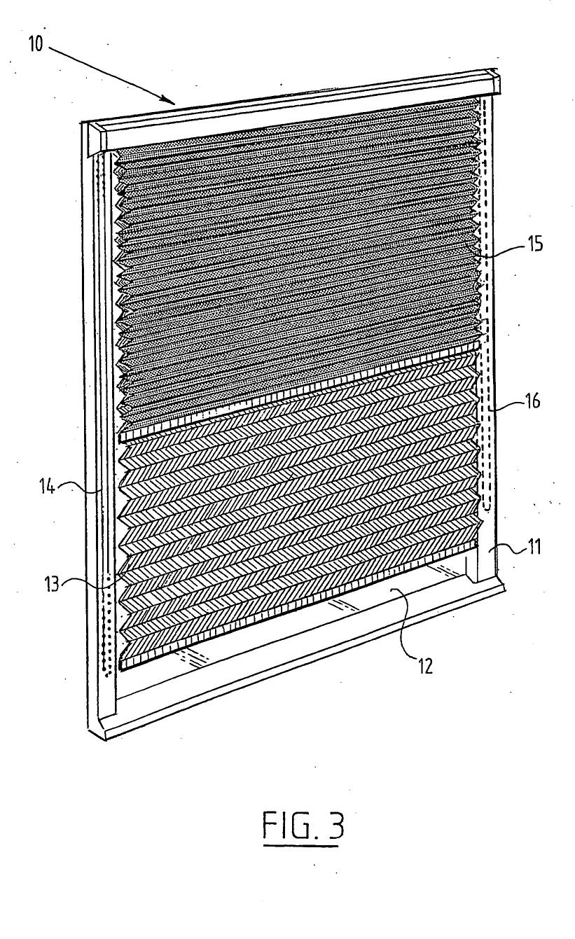

FIG. 3 shows a second embodiment of a window decoration according to the invention.

In FIGS. 1 and 2 a window decoration 1 is shown in two different-positions. This window decoration 1 is placed in front of a window pane 3 placed in a window frame 2. The window decoration 1 has a first roller blind 4, which can be operated by a pull cord 5, and a second roller blind-6 which can be operated by a second pull cord 7. Pull cord 7 can also be replaced by other operating elements such as an electric motor.

In the two FIGS. 1 and 2, the first roller blind 4 has a transparency of for instance 20%. The second roller blind 6 has for instance a transparency of 5%. In FIG. 1 only the first roller blind 4 is partially lowered. Thus is created a lower part with a transparency of 100%, since this is not covered with a roller blind, and an upper part with a transparency of 20% which is only covered with roller blind 4.

In FIG. 2 the first roller blind 4 is lowered further, so that only a small bottom gap is present where the window 3 is uncovered and thus has a transparency of 100%. Only the roller blind 4 is present thereabove, so that here there is a transparency of 20%. In addition, roller blind 6 is partially lowered. Since this roller blind 6 itself has a transparency of 5%, there results a transparency of 5% x 20%=1% in the upper part through the combination of roller blind 4 and roller blind 6.

Instead of lowering the first roller blind 4 first, it is also possible to lower the second roller blind 6 first. Sections can thus be created with a transparency of 100%, 5% and 1%. It is thus possible to vary the light-transmission of the window, wherein eye contact with the outside world can be retained.

FIG. 3 shows a second embodiment of a window decoration 10 according to the invention. This second window decoration 10 is likewise arranged in front of a pane 12 arranged in a window frame 11.

The window decoration 10 has a first pleated blind 13 which can be operated by means of a pull cord 14 and a second pleated blind 15 which can be operated with a second pull cord 16.

It is here also recommended that the pleated blind 13 has a different transparency than pleated blind 15. This second embodiment of a window decoration 10 according to the invention further has the same variation options as the window decoration 1 according to FIGS. 1 and 2.

It will further be apparent that roller blinds or combinations thereof are also possible in addition to pleated blinds.

1. Window decoration for partially or wholly covering a window as desired, which window decoration comprises:
a first displaceable window covering element; and
a second displaceable window covering element arranged parallel to the first window covering element, characterized in that both window covering elements are transparent.

2. Window decoration as claimed in claim 1, characterized in that the first window covering element has a transparency differing from that of the second window covering element.

3. Window decoration as claimed in claim 2, characterized in that the first window covering element has a transparency in the range of 2%-50% and the second window covering element has a transparency in the range of 1%-10%.

4. Window decoration as claimed in claim 2, characterized in that the first window covering element has a transparency of 20% and the second window covering element has a transparency of 5%.

5. Window decoration as claimed in claim 1, characterized in that the first and second window covering elements each comprise one of a roller blind or a pleated blind.
